(19) United States
(12) Patent Application Publication
(10) Pub. No.: US 2013/0016504 A1
(43) Pub. Date: Jan. 17, 2013

(54) LIGHTING FIXTURE MOUNTING SYSTEM AND METHOD

(71) Applicant: Thomas A. Garber, Mount Pleasant, SC (US)

(72) Inventor: Thomas A. Garber, Mount Pleasant, SC (US)

(73) Assignee: Quoizel, Inc., Goose Creek, SC (US)

(21) Appl. No.: 13/547,239

(22) Filed: Jul. 12, 2012

Related U.S. Application Data
(60) Provisional application No. 61/508,361, filed on Jul. 15, 2011.

(51) Int. Cl. F21V 17/12; B23P 17/00; F21V 21/00

(52) U.S. Cl. 362/217.16; 29/418; 29/407.05

(57) ABSTRACT

A system for mounting a lighting fixture to a surface may include an elongate mounting member (“EMM”) and a retaining element. The EMM may include a first end, a second end, and a shaft therebetween. The second end of the EMM may be configured to connect to a fixture mounting screw that is attached to a mounting surface, and the EMM may be configured to be received by an aperture defined by a fixture pan of the light fixture. The retaining element may be configured to be removably attachable to a portion of the shaft of the EMM and, when attached to the EMM, configured to support a fixture pan of the light fixture while the fixture pan is separated a distance from the mounting surface. This allows an installer to perform operations between the fixture pan and the mounting surface without the installer having to support the fixture pan.

This application claims priority to co-pending provisional patent application Ser. No. 61/508,361, filed on Jul. 15, 2011, the entire disclosure of which is incorporated herein by reference.

### BACKGROUND

Some embodiments of the present invention relate generally to mounting a lighting (or ‘light”) fixture. More particularly, some embodiments of the invention relate to a system and method using an elongate mounting member for mounting a lighting fixture to a surface.

A room may have multiple lighting fixtures, each in electrical communication with a light switch via the building's wiring. In particular, a pair of conductors extends between each switch and an associated electrical outlet box to which the lighting fixture is mounted. Typically, the outlet box is mounted to be flush with a surface, such as a wall or ceiling, and a mounting bracket or the like is generally connected to the outlet box. Before the fixture may be fastened to the mounting bracket, the fixture's electrical wires must be connected to the building conductors to complete a circuit. This is often a cumbersome process for an installer since the fixture is not supported while making the electrical connections. After the circuit is complete, the fixture is connected to the mounting bracket using screws or other fasteners. These fasteners typically extend outward from the junction box and mounting bracket to receive the fixture,

### SUMMARY OF EMBODIMENTS OF THE INVENTION

According to one embodiment, a method for mounting a lighting fixture to a mounting surface includes attaching an elongate mounting member (EMM) to a fixture mounting screw so that the EMM is supported by the fixture mounting screw. The EMM may be disposed through an aperture of a fixture pan of the lighting fixture. A retaining element may be connected to the EMM so that the retaining element supports the fixture pan while the fixture pan is separated from the mounting surface, thereby allowing an installer to perform operations without the installer having to manually support the fixture pan. The fixture pan may be moved along the EMM towards the mounting surface, and the EMM may then be removed from the fixture mounting screw. The installation of the light fixture may then be completed (e.g., attaching cap nuts, attaching a glass shade, etc.).

According to another embodiment, a system for mounting a light fixture to a surface includes an elongate mounting member (“EMM”) and a retaining element. The EMM may include a first end, a second end, and a shaft therebetween. The second end of the EMM may be configured to connect to a fixture mounting screw that is attached to a fixed mounting structure, and the EMM may be configured to be received by an aperture defined by a fixture pan of the light fixture. The retaining element may be configured to be removably attachable to a portion of the shaft of the EMM and, when attached to the EMM, configured to support a fixture pan of the light fixture while the fixture pan is separated a distance from the mounting structure. This allows an installer to perform operations between the fixture pan and the mounting surface without the installer having to manually support the fixture pan.

According to another embodiment, a method for mounting an object to a mounting surface includes attaching a proximate end of an elongate mounting member (“EMM”) to a structure so that the EMM is fixed with respect to the mounting surface, and disposing a distal end of the EMM through an aperture of the object. A retaining element may be connected at a selected location on the EMM so that the retaining element supports the object while the object is separated from the mounting surface, thereby allowing a user to perform operations without the installer having to manually support the object. Installation of the object to the mounting surface may then be completed, and the EMM may be removed from the mounting surface and from the object.

According to yet another embodiment, a method for mounting a lighting fixture to a wall may include attaching an elongate mounting member (“EMM”) to a fixture mounting screw so that the EMM is supported by the fixture mounting screw; disposing the EMM through an aperture of a fixture pan of the lighting fixture so that the EMM supports the fixture pan while the fixture pan is separated from the wall, thereby allowing an installer to perform operations without the installer having to hold the fixture pan; moving the fixture pan along the EMM towards the wall; and removing the EMM from the fixture mounting screw.

Other embodiments formed by various combinations and subcombinations of the disclosed elements are within the scope of the present invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is an exploded view of an exemplary lighting fixture with mounting parts, including an elongate mounting member and a corresponding retaining element according to an embodiment.

FIG. 2 is flow chart showing various steps of a method of mounting a lighting fixture according to an embodiment.

FIG. 3A illustrates an elongate mounting member used in measuring the fixture pan of the lighting fixture of FIG. 1 to position a marker element on the elongate mounting member according to an embodiment.

FIG. 3B illustrates a side view of the elongate mounting member and marker element of FIG. 3A during measurement of the fixture pan according to an embodiment.

FIG. 4 illustrates the elongate mounting member with the marker element positioned as in FIGS. 3A and 3B and being used with the mounting bracket of the lighting fixture of FIG. 1 to adjust the length of the fixture mounting screws according to an embodiment.

FIG. 5 is an exploded view showing attachment of the mounting bracket and mounting screws adjusted as in FIG. 4 to an outlet box according to an embodiment.

FIG. 6A is a view similar to FIG. 5 but showing the manner in which elongate mounting members are connected with respective fixture mounting screws according to an embodiment.

FIG. 6B is a diagrammatic cross-sectional view of an elongate mounting member attached to a fixture mounting screw according to an embodiment.

FIG. 7 is a perspective view of the fixture pan of the lighting fixture of FIG. 1 coupled with the elongate mounting members shown in FIG. 6 according to an embodiment.

FIG. 8 is a view similar to FIG. 7 but showing the fixture pan supported in place on the elongate mounting members via respective retaining elements positioned on each elongate mounting member according to an embodiment.

FIG. 9 illustrates mounting of the fixture pan of the lighting fixture of FIG. 1 against the ceiling according to an embodiment.

FIG. 10 illustrates installation of the cage and glass bowl of the exemplary lighting fixture of FIG. 1 to complete the installation according to an embodiment.

FIG. 11A is an enlarged side view of a retaining element coupled with an elongate mounting member according to a further embodiment.

FIG. 11B is a view of the retaining element and elongate mounting member taken along line 11B-11B of FIG. 11A.

FIG. 12 is a perspective view of a fixture pan of the lighting fixture coupled with the elongate mounting members and the retaining members being v-springs as in FIGS. 11A-B.

FIG. 13 is a view similar to FIG. 12 but showing the fixture pan supported in place on the elongate mounting members via respective retaining elements positioned on each elongate mounting member according to an embodiment.

FIG. 14 illustrates mounting of the fixture pan of the lighting fixture of FIG. 12 flush against the ceiling according to an embodiment.

FIG. 15 is a diagrammatic partial cross-sectional view of an elongate mounting member with a fixture mounting screw being threaded into an end of the elongate mounting member according to an embodiment.

FIG. 16 is a flowchart showing steps of a method of mounting a lighting fixture to a vertical wall according to another embodiment.

FIG. 17 illustrates an elongate mounting member used in measuring a fixture pan of a lighting fixture to position a marker element on the elongate mounting member according to an embodiment.

FIG. 18 illustrates a side view of the elongate mounting member and marker element of FIG. 17 during measurement of the fixture pan according to an embodiment.

FIG. 19 illustrates the elongate mounting member with the marker element positioned as in FIGS. 17 and 18 and used with an exemplary mounting bracket to adjust the length of the fixture mounting screws according to an embodiment of the present invention.

FIG. 20 is an exploded view showing attachment of the mounting bracket and mounting screws adjusted as in FIG. 19 to an outlet box according to an embodiment.

FIG. 21 is a view similar to FIG. 20 but showing the manner in which elongate mounting members are connected with respective fixture mounting screws.

FIG. 22 is a perspective view of the fixture pan of the lighting fixture of FIG. 17 supported in place on the elongate mounting members according to an embodiment.

FIG. 23 is a view similar to FIG. 22 but showing the fixture pan supported in place on the elongate mounting members so that the wiring can be completed according to an embodiment,

FIG. 24 illustrates mounting of the fixture pan of the lighting fixture of FIG. 17 against the wall according to an embodiment.

FIG. 25 illustrates installation of the cage and glass portion of the lighting fixture of FIG. 17 to complete the installation according to an embodiment.

FIG. 26 is a flowchart showing steps of a method of mounting a light fixture with a center stem according to an embodiment.

FIG. 27 illustrates an elongate mounting member and marker element used with a mounting bracket having a center stem to adjust the length of the center stern according to an embodiment,

FIG. 28 is an exploded view showing connection between the mounting bracket of FIG. 27 and an outlet box according to an embodiment,

FIGS. 28A-B are exploded views showing connection between the mounting bracket of FIG. 27 and an outlet box according to a further embodiment,

FIG. 29 is a perspective view of the fixture pan of a lighting fixture utilizing the mounting bracket of FIG. 27 coupled with the elongate mounting member according to an embodiment.

FIG. 30 is a view similar to FIG. 29 but showing the lighting fixture supported in place on the elongate mounting member via a retaining element positioned on the elongate mounting member according to an embodiment.

FIG. 31 illustrates mounting of the fixture pan of the lighting fixture of FIG. 27 against the ceiling according to an embodiment.

FIG. 32 is flowchart showing steps of a method of mounting an object to a mounting surface using an elongate mounting member and a retaining element according to an embodiment.

FIG. 33 is a diagrammatic side view showing an object being mounted to a mounting surface using an elongate mounting member and a retaining element according to an embodiment.

FIG. 34A is a diagrammatic side view showing an object being mounted to a mounting surface using an elongate mounting member and a retaining element according to another embodiment.

FIG. 34B is a diagrammatic side view showing an object being mounted to a mounting surface using an elongate mounting member and a retaining element according to yet another embodiment,

Repeat use of reference characters in the present specification and drawings is intended to represent same or analogous features or elements of the invention.

### DETAILED DESCRIPTION OF PREFERRED EMBODIMENTS

Reference will now be made in detail to various embodiments, examples of which are illustrated in the accompanying drawings. Each example is provided by way of explanation of the embodiments of the invention, not limitation of the invention. In fact, it will be apparent to those skilled in the art that modifications and variations can be made without departing from the scope or spirit of the invention. For instance, features illustrated or described as part of one embodiment may be used on another embodiment to yield a still further embodiment. Thus, it is intended that the present invention covers such modifications and variations as come within the scope of the appended claims and their equivalents.

Some preferred embodiments of the present invention provide a system and method for mounting a lighting fixture to a ceiling or wall. For example, it is often difficult for an installer to install fixture mounting fasteners in a mounting bracket of a lighting fixture to an appropriate length without making several time-consuming adjustments. If the fasteners are adjusted to be too short, the lighting fixture cannot be mounted. But if the fasteners are adjusted to be too long, the fasteners may protrude from the lighting fixture or the lighting fixture may not be mounted flush against the surface. Generally, according to some embodiments, the mounting system includes at least one elongate mounting member (“EMM”) configured to receive a retaining element at one or more locations along the length thereof The EMM and retaining element may be used to facilitate mounting of a lighting fixture or other suitable object. As will be described with reference to the Figures, the EMM and a marker element such as the retaining element itself may be used to select the correct length of lighting fixture mounting screws and to support a lighting fixture while electrical and/or mechanical connections are made.

Those of skill in the art will appreciate that the present invention is not limited to mounting a light fixture to a ceiling, in fact, aspects of the present invention may be used with any suitable lighting fixture (e,g., a track lighting fixture, a flush or send-flush pendant light fixture, an emergency light fixture, a sconce light fixture, or any other type of ceiling/wall mounted light fixture) on any surface, such as a ceiling, a vertical wall, etc. Additionally, embodiments of the present invention may be used in securing various objects to a surface, as will be described in detail below. For example, the EMMs of the present disclosure may be used to install a keyboard tray to an underneath surface of a desk. In this regard, the EMMs of the present disclosure may be used to support the keyboard tray so that an installer can easily secure fasteners without having to use one hand to hold the keyboard tray while securing (e.g., screwing in) such fasteners.

### Mounting a Light Fixture Using EMM(s)

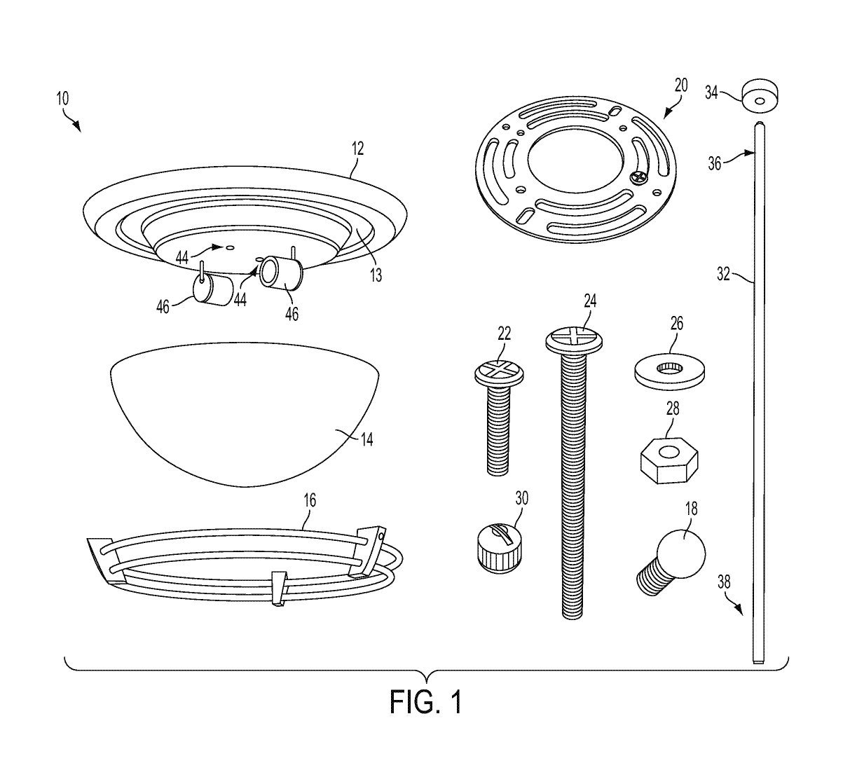

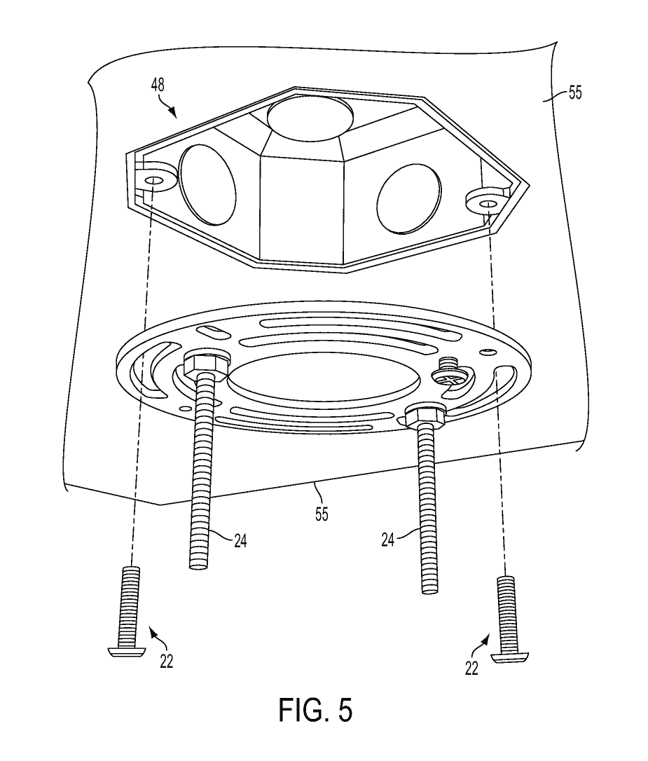

FIG. 1 illustrates an exploded view of an exemplary lighting fixture 10 with which embodiments of the present invention may be used. The lighting fixture 10 illustrated in FIG. 1 is a surface mounted lighting fixture that mounts flush against a mounting surface 55 (FIG. 5) such as a ceiling. The particular lighting fixture 10 of FIG. 1 includes a fixture pan 12 which defines an alignment groove 13 to receive a shade in the form of a glass bowl 14. The fixture pan 12 defines mounting holes 44 and includes bulb sockets 46. The mounting holes 44 allow for the fixture mounting screws 24 to extend through the fixture pan 12 for securing the fixture pan 12 against the mounting surface 55. The EMMs 32 are sized to have an outer diameter slightly smaller than the mounting holes 44 so that the EMMs 32 can extend through such mounting holes 44.

In this case, a cage 16 supports the glass bowl 14 and may be coupled with the fixture pan 12 using cage mounting screws 18 or other suitable type of fastener. The lighting fixture 10 may further include a conventional mounting bracket 20 for coupling the fixture pan 12 with an outlet box or the like. In this case, mounting bracket 20 is shown as a circular mounting bracket, although one skilled in the art will appreciate that other conventional mounting brackets could be used. As shown in FIG. 5, the mounting bracket 20 may be coupled with an outlet box 48 via outlet mounting screws 22. As described in more detail below, fixture mounting screws 24 may be coupled with the mounting bracket 20 via washers 26 and hex nuts 28 after being adjusted to the appropriate length. The lighting fixture 10 may further include cap nuts 30 to secure the fixture pan 12 to the fixture mounting screws 24.

An EMM 32 and a corresponding retaining element 34 according to an embodiment is also shown in FIG. 1. EMM 32 may be configured as a rod, such as a 3/16″ diameter rod. The rod may be substantially straight and have a shaft extending a length along a longitudinal axis. Thus, the EMM 32 defines a proximal end 36 and a distal end 38. The EMM 32 may be made from any suitable material, such as steel, thin-walled aluminum, plastic or any other material which is configured to support weight of the fixture pan 12. The length of the EMM 32 may vary and in some embodiments, may be 24″ long.

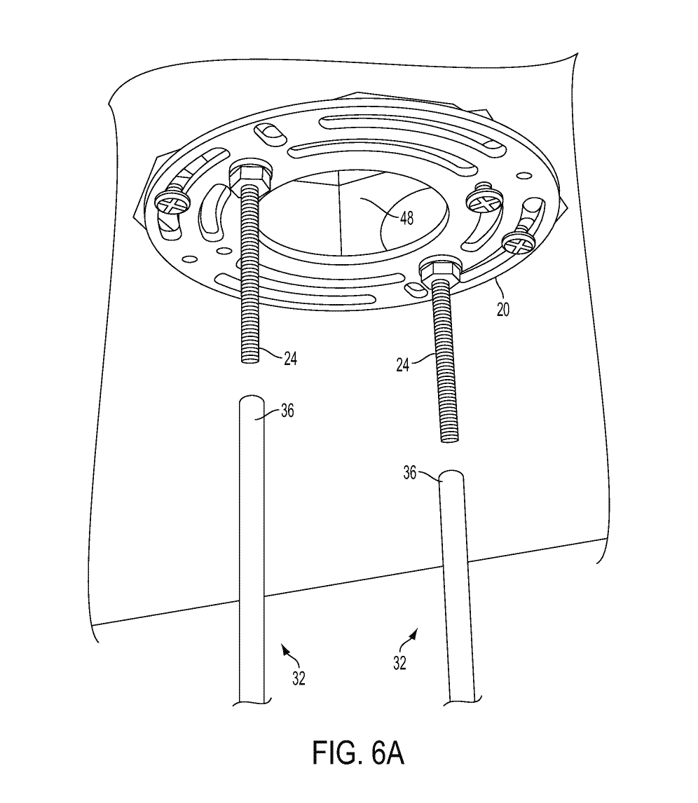

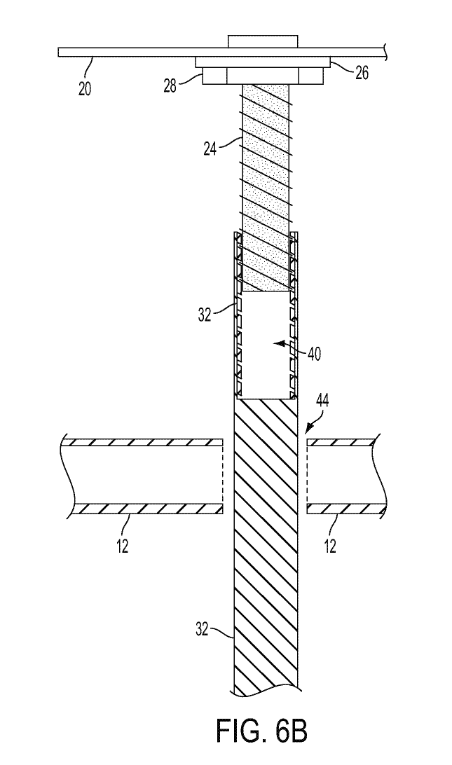

The proximal end 36 of the EMM 32 may be substantially solid or hollow to define a bore 40 (shown in FIG. 6B) configured to couple with fasteners for mounting an associated lighting fixture. For example, if the EMM 32 is used to the mount the lighting fixture 10 of FIG. 1, the bore 40 may be internally threaded and sized to engage with the external threads of the mounting screws 24. The bore 40 may not be threaded in all embodiments, and in some embodiments, the distal end 38 may also define a bore. In some embodiments, more than one EMM 32 may be provided for mounting the lighting fixture 10. For example, it will often be desirable to provide a pair of EMMs 32 respectively corresponding to individual mounting screws 24.

In this embodiment, the retaining element 34 may resemble a washer and have a cylindrical body defining an aperture through which EMM 32 will extend. The retaining element 34 may, for example, be formed of rubber or other suitable resilient material. The aperture of element 34 may be sized to be slidably but snugly received over the EMM 32 such that when the retaining element 34 is located along the EMM 32 it will tend to maintain its position until intentionally removed. For example, in this embodiment, when the retaining element 34 is attached to the EMM 32, the retaining element 34 supports the weight the lighting fixture 10 on the EMM 32 during installation of the fixture 10. In this regard, the EMM 32 may have a knurled or otherwise textured exterior surface that enhances friction between the retaining element 34 and EMM 32 to inhibit the retaining element 34 from slipping down the shaft of the EMM 32. While the retaining element 32 is described as a resilient (e.g., rubber) washer in this embodiment, one skilled in the art will appreciate that the retaining element 34 may be any other suitable article, such as a v-spring, cotter pin, hitch pin, an O-ring, or any other retaining element that allows the fixture pan 12 to be supported by a combination of the EMM 32 and retaining element 34.

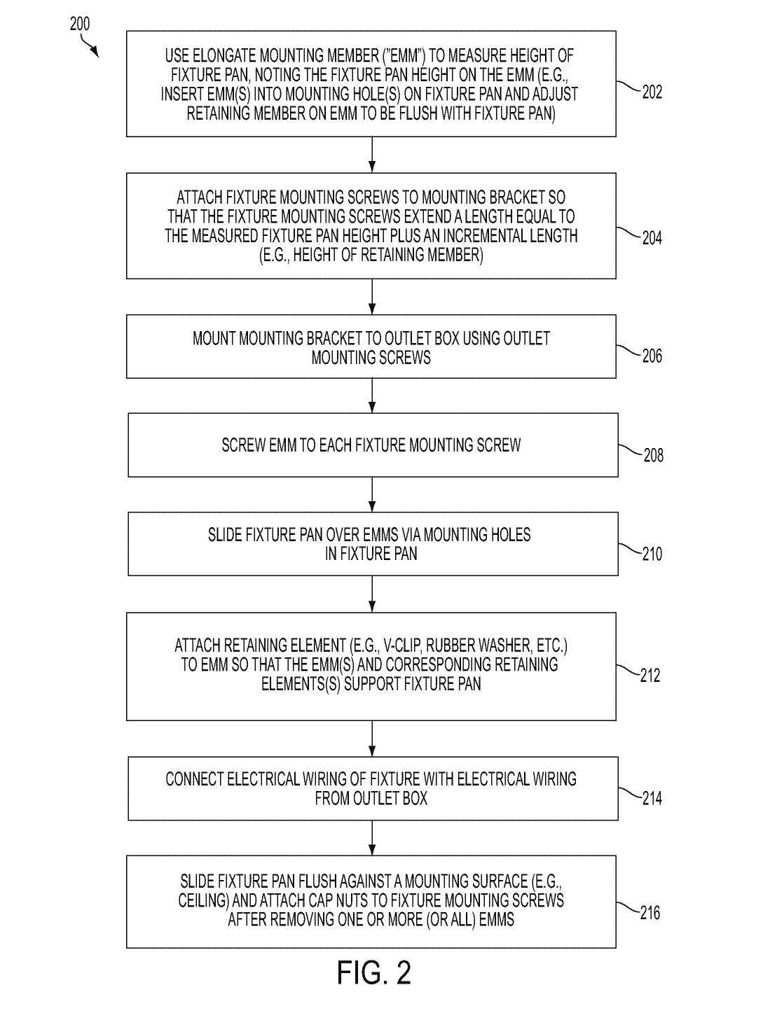

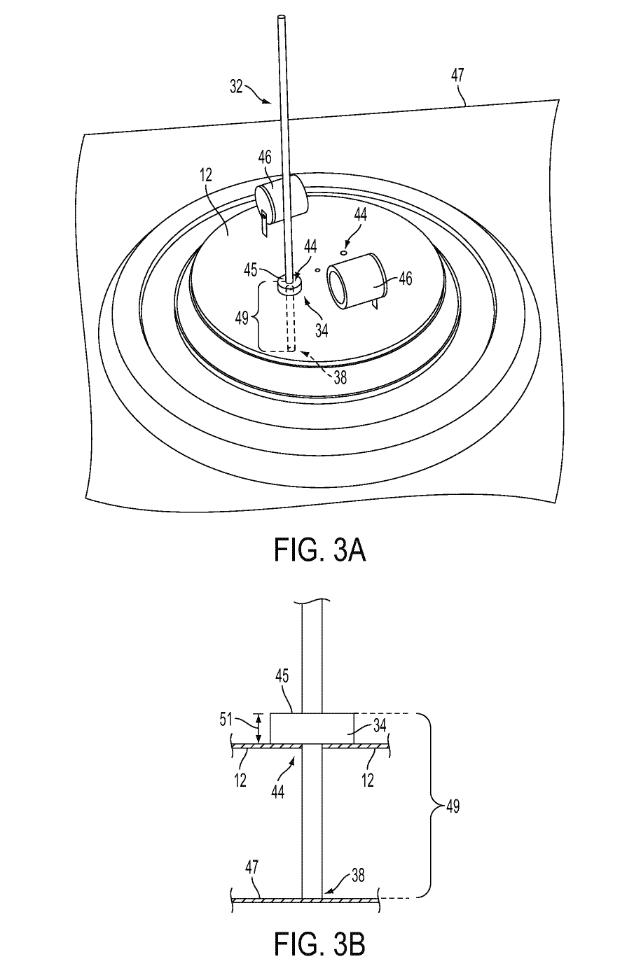

FIG. 2 is a flow chart of a method 200 of installing the light fixture 10 using the EMM 32 and corresponding retaining element 34 according to some embodiments. For ease of discussion and illustration, a brief overview of this method 200 will now be presented, and a more in depth discussion thereof will be presented with regard to FIGS. 3-10, in block 202 of FIG. 2, the EMM 32 is used to measure the height of the fixture pan 12, noting the height of the fixture pan 12 on the EMM 32. In block 204, the fixture mounting screws 24 are attached to the mounting bracket 20 so that the fixture mounting screws 24 extend from the mounting bracket 20 by a length equal to the measured fixture pan height on EMM 32 plus an incremental length (e.g., the height of the retaining element 34). In block 206, the mounting bracket 20 is mounted to an outlet box using the outlet mounting screws 22. In block 208, a respective EMM 32 is attached to each fixture mounting screw 24. In block 210, the fixture pan 12 is slid over each EMM via mounting holes 44 in fixture pan 12. In block 212, the retaining elements 34 are attached to each respective EMM 32 so that the EMMs 32 and corresponding retaining elements 34 support the fixture pan 12. In block 214, the electrical wiring of the light fixture 10 (and/or other operations) is completed, which is facilitated since the fixture pan 12 is supported by the EMM 32 and corresponding retaining elements 34. In block 216, the fixture pan 12 is moved into position flush against the mounting surface, and the cap nuts 30 are attached to the fixture mounting screws 24.

FIGS. 3A-3B illustrate block 202 of FIG. 2 where the EMM 32 is used with the fixture pan 12 of the lighting fixture 10 of FIG. 1 to position a marker element 34 on the EMM 32 according to an embodiment. In this case, retaining element 34 is used as the marker element. According to one embodiment, the fixture pan 12 is placed on a flat surface 47 (e.g., a table, the floor, etc.) with the sockets 46 facing upward as shown in FIG. 3A. The EMM. 32 is then inserted through one of the mounting holes 44 until the distal end 38 of the EMM 32 engages the flat surface 47. The retaining element 34 is then slid down over the EMM 32 until the retaining element 34 is adjacent to the fixture pan 12. In this position (illustrated in FIG. 3B), the distance 49 between the distal end 38 of the EMM 32 and the top 45 of the retaining element 34 represents the correct height to which the fixture mounting screws 24 should be adjusted to extend from the mounting bracket 20. It should be noted that the measured distance 49 includes the incremental length 51 (the thickness of the retaining element 34) so as to allow the fixture mounting screws 24 to extend through the mounting holes 44 of the fixture pan 12 by such incremental length 51, thereby providing some extension to which the cap nuts 30 are secured. While the retaining element 34 may be used as the incremental length portion of the measured distance 49 in this case, any other suitable device could be used in measuring the incremental length. Alternatively, the user could simply add an incremental length to the measured height of the fixture pan 12. Regardless of the method of determining the combined distance 49 between the height of the fixture pan 12 and an incremental length, such distance may be noted on the EMM 32 for future reference, as is discussed below.

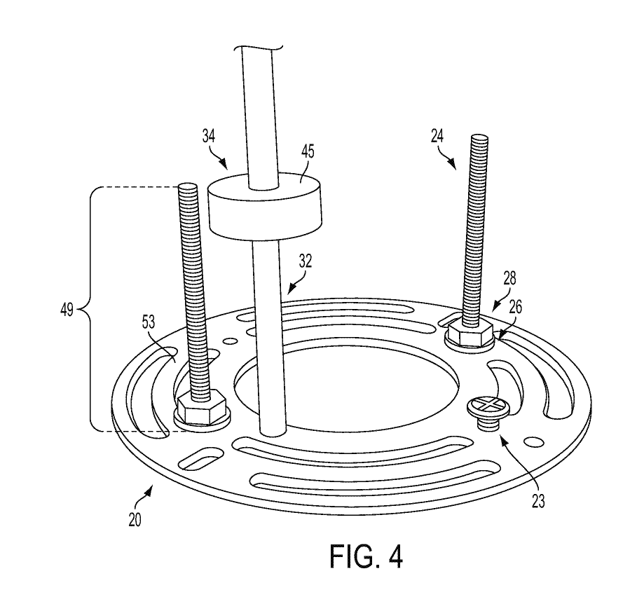

Reference will now be made to FIG. 4 for additional explanation of block 204 of FIG. 2 where the fixture mounting screws 24 are attached to the mounting bracket 20. As illustrated, the EMM 32 is removed from the fixture pan 12 and placed substantially perpendicular to the mounting bracket 20. The fixture mounting screws 24 are inserted upwards through the mounting bracket 20 and adjusted such that the lengths of the shanks of the fixture mounting screws 24 extending above the top surface 53 of the mounting bracket 20 substantially equal the measured distance 49 between the distal end 38 of the EMM 32 and the top surface 45 of the retaining element 34. The fixture mounting screws 24 may then be secured at this measured distance 49, such as via washer 26 and hex nut 28.

FIG. 5 relates to block 206 of FIG. 2 where the mounting bracket 20 may be coupled with an outlet box 48 via the outlet mounting screws 22. Once the outlet mounting screws 22 secure the mounting bracket 20 to the outlet box 48, the mounting bracket 20 may be flush with the ceiling 55 with the fixture mounting screws 24 extending downward by the predetermined distance 49.

The installed mounting bracket 20 is illustrated in FIG. 6A. As shown and as previously presented in block 208 of FIG. 2, two EMMs 32 may be used to mount the lighting fixture 10 over the outlet box 48. In particular, the proximal ends 36 of the EMMs 32 (which may define threaded bores 40 as previously discussed) are screwed onto the fixture mounting screws 24 such that any downward forces applied to the EMMs 32 are also applied to the fixture mounting screws 24. As a result, the EMMs 32 will be supported from the mounting bracket 20.

FIG. 6B illustrates a side cross-sectional view of one EMM 32 threadably engaging the fixture mounting screw 24 according to one embodiment. As illustrated, the EMM bore 40 is threaded so as to receive the threads of the fixture mounting screw 24. Once the fixture mounting screw 24 is threaded into the bore 40 of the EMM 32 in this manner, weight applied to the EMM 32 will also be borne by the fixture mounting screw 24.

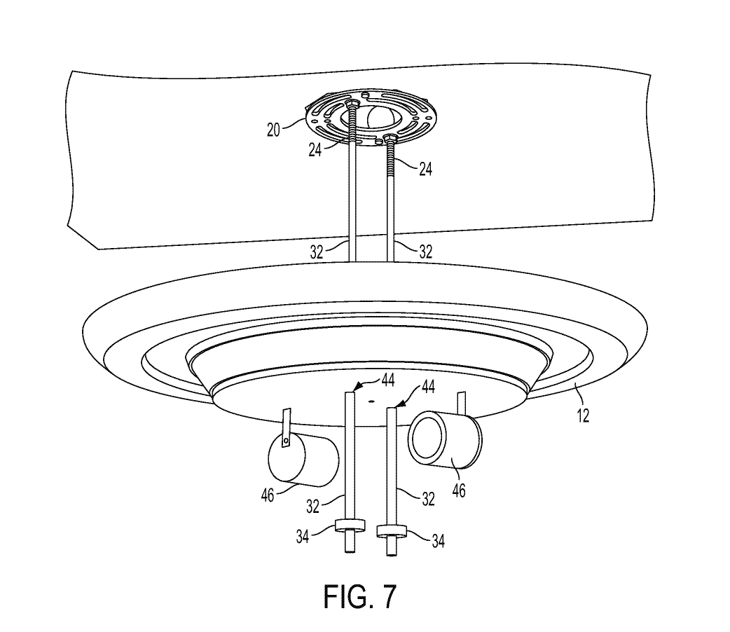

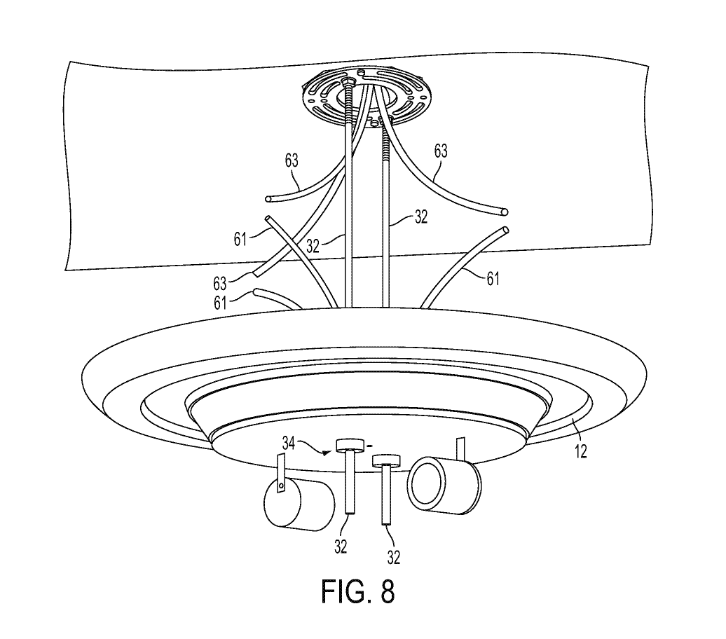

FIG. 7 relates to block 210 of FIG. 2 where the fixture pan 12 is slid over the attached EMMs 32 via the mounting holes 44. In another embodiment, the EMM 32 may have one end that is somewhat pointed (or tapered) so that the EMM 32 will more easily penetrate through any insulation or other materials located on the back side of fixture pan 12. The retaining elements 34 are placed on the EMMs 32 at a desired distance from mounting bracket 20. The fixture pan 12 may then be slowly lowered onto the retaining elements 34 such that the fixture pan 12 will be supported at the desired distance away from the ceiling. In FIG. 8, The fixture pan 12 is shown fully supported by a combination of the EMMs 32 and retaining elements 34 at the desired distance away from the ceiling (described at block 212 of FIG. 2).

It will be appreciated that, as a result of the fixture pan 12 being fully supported by a combination of the EMMs 32 and retaining elements 34, an installer's hands are now free to complete electrical connections (and/or perform other operations) that are necessary or desirable during installation of lighting fixture 10. For example, after stripping the ends of the electrical wires, the installer may use suitable wire connectors to complete the electrical circuit. If necessary, the installer may wrap each connection with electrical tape. Finally, the installer may move the connected wires into outlet box 48 so that the fixture pan 12 may be pushed against the mounting surface 55 (block 214). It should be understood that the installer may perform other tasks while the fixture pan 12 is being supported by the EMMs 32 other than connecting electrical wires, such as adjusting the mounting bracket 20, adjusting the outlet mounting screws or fixture mounting screws.

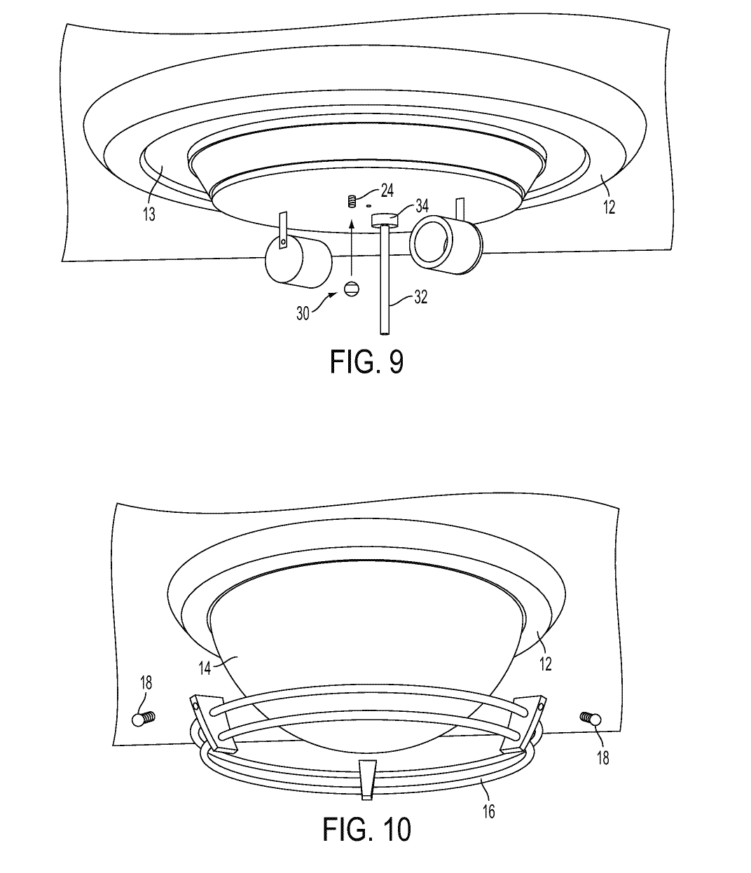

As shown in FIG. 9 and as previously discussed in block 216, the fixture pan 12 is slid upwards along the EMMs 32 toward the mounting surface. As the fixture pan 12 is moved into place against the mounting surface, one of the retaining elements 34 is similarly slid upwards to maintain the fixture pan 12 substantially flush against the mounting surface. Once again, an installer's hands remain free to complete the installation. To do so, the other EMM 32 is separated from its fixture mounting screw 24 and replaced with a first cap nut 30. The retaining element 34 of the other EMM 32 may maintain and support the fixture pan 12 in place while the first cap nut 30 is installed. Once the first cap nut 30 is installed, the remaining EMM 32 can be removed and replaced with a second cap nut 30. Both cap nuts 30 are securely tightened.

After the fixture pan 12 is installed, the installation of the light fixture may be completed. For example, referring now to FIG. 10, after providing light bulbs appropriate for lighting fixture 10, an installer will then place the bowl 14 in position in the alignment groove 13. While holding the bowl 14 in place, the installer then may mount the cage 16 over the bowl 14 and attach the cage 16 to fixture pan 12 using the cage mounting screws 18. After the installer securely tightens the cage mounting screws 18, the lighting fixture 10 is ready for use.

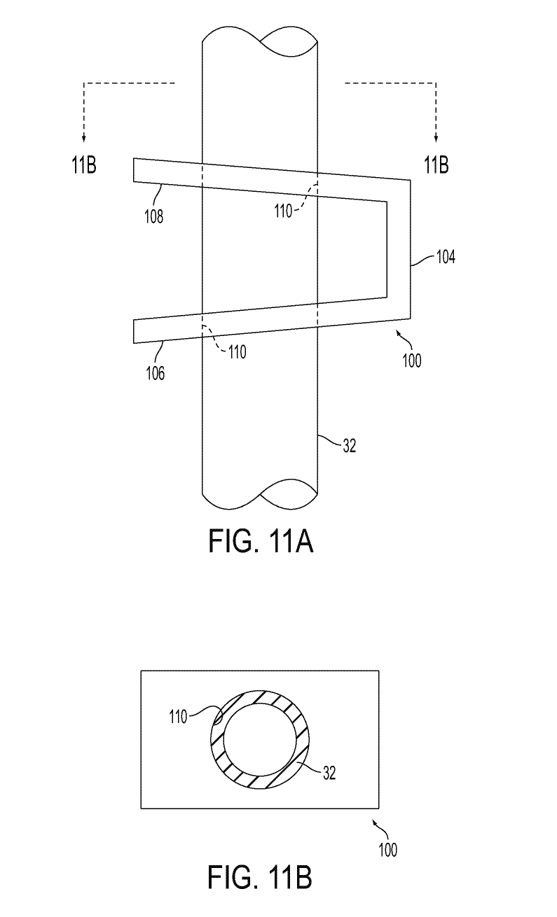

Those of skill in the art will appreciate that the retaining elements 34 may take many forms within the scope of the present invention. For example, as illustrated in FIGS. 11A-B, a retaining element 34 may be a v-spring 100, which includes a clip-like body 104, first leg 106 and second leg 108. Apertures 110 are defined through the first and second legs 106, 108 of the v-spring 100 and have a diameter slightly larger than the outer diameter of the EMM 32. Preferably, the first and second legs 106, 108 are biased outward at an oblique angle from a plane that is perpendicular to the vertical axis of the EMM 32. When the first and second legs 106, 108 are compressed so as to be parallel with each other (and thus, perpendicular to the vertical axis of EMM 102), the v-spring 100 may be received over and slid along the EMM 32. After the decompression force is removed, however, the first and second legs 106, 108 again may bias outward and secure the v-spring 100 in place along EMM 32.

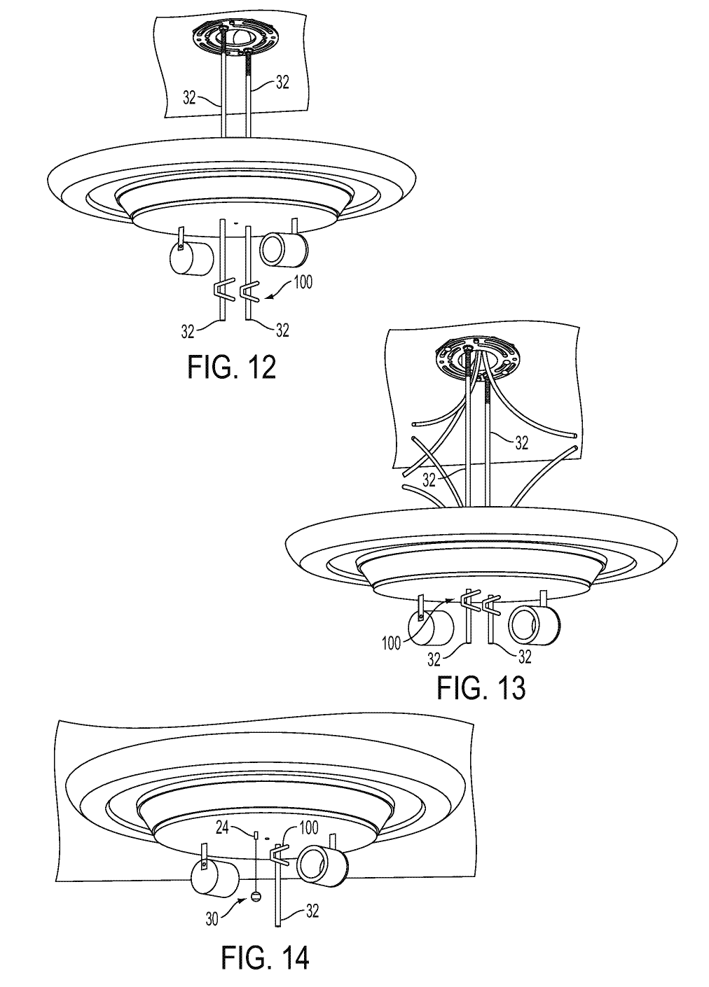

FIGS. 12-14 illustrate use of v-springs 100 in mounting a lighting fixture. As previously discussed with regard to blocks 202-210 and FIGS. 3-6, the fixture mounting screws 24 are attached to the mounting bracket 20 such that they extend the desired distance 49 measured by the EMM 32 and a suitable marker element. After the mounting bracket 20 is mounted to the outlet box 48, respective EMMs 32 are attached to the fixture mounting screws 24. Then, as illustrated in FIG. 12, the v-springs 100 may be used as a retaining element 34 on the EMMs 32, (In this case, it may still be desirable to use a resilient washer as a marker element to measure distance 49.) The v-springs 100 are then attached to the EMMs 32 and may be used to support the fixture pan 12, as illustrated in FIG. 13. Then, as illustrated in Figure 14, the fixture pan is pushed against the mounting surface. The EMMs 32 are then removed one at a time, and cap nuts 30 are attached to the respective fixture mounting screws 24.

The retaining elements 34 could be any other element configured to be releasable attached to the EMM 32, such as a cotter or hitch pin received in a transverse aperture in the EMM 32, an O-ring which would attach to the EMM 32 via grooves in the EMM 32, or any other device or system which may allow the fixture pan 12 to be supported by the EMM 32. In the case of a cotter or hitch pin, a series of transverse apertures may be spaced apart along the length of the EMM 32 to allow placement at multiple locations.

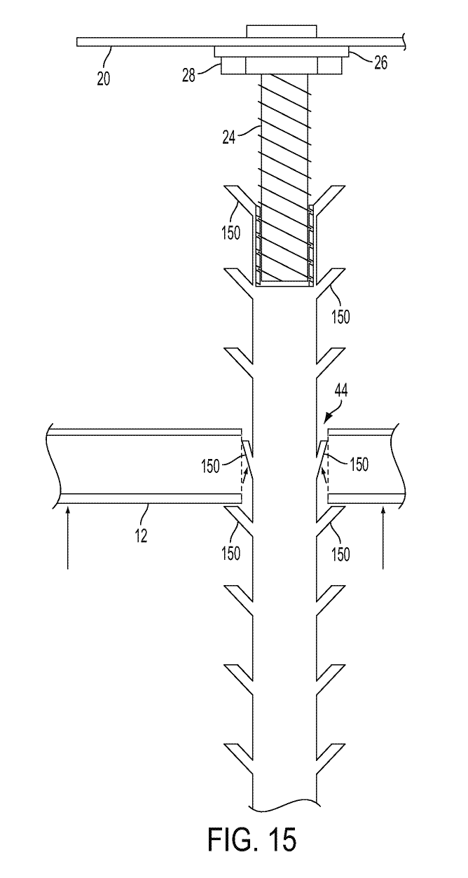

FIG. 15 illustrates an embodiment in which the retaining element 34 is formed as an integral part of the EMM 32 whereby the retaining element 34 does not separate from the EMM 32. In this embodiment, for example, the EMM 32 may include resilient members 150 formed as tangs along the shaft of the EMM 32. Members 150 bend inwards toward the EMM shaft as the fixture pan 12 is slid toward the mounting bracket 20. After passing through hole 44, the members 150 assume their original shape so as to not allow the fixture pan 12 to be slid in a reverse direction on the EMM 32. The resilient members 150 thus act to support the fixture pan 12 when they are not compressed. In this case, the EMM is removed by loosening it from the threads of screw 24 and pulling sharply down.

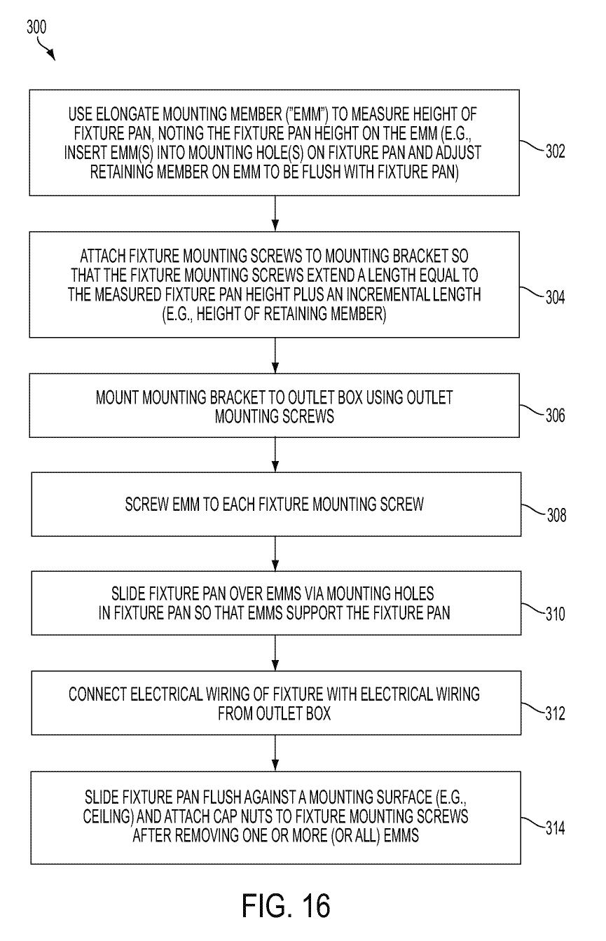

FIGS. 1-15 illustrate systems and methods for a ceiling-mounted lighting fixture. However, it should be understood that the lighting fixture could be other types of fixtures, such as an indoor wall-mounted lighting fixture a wall sconce), an outdoor wall-mounted lighting fixture or any other fixture that could be mounted to a wall. FIGS. 16-25 illustrate a method 300 and system of mounting a wall-mounted sconce to a vertical wall according to some embodiments.

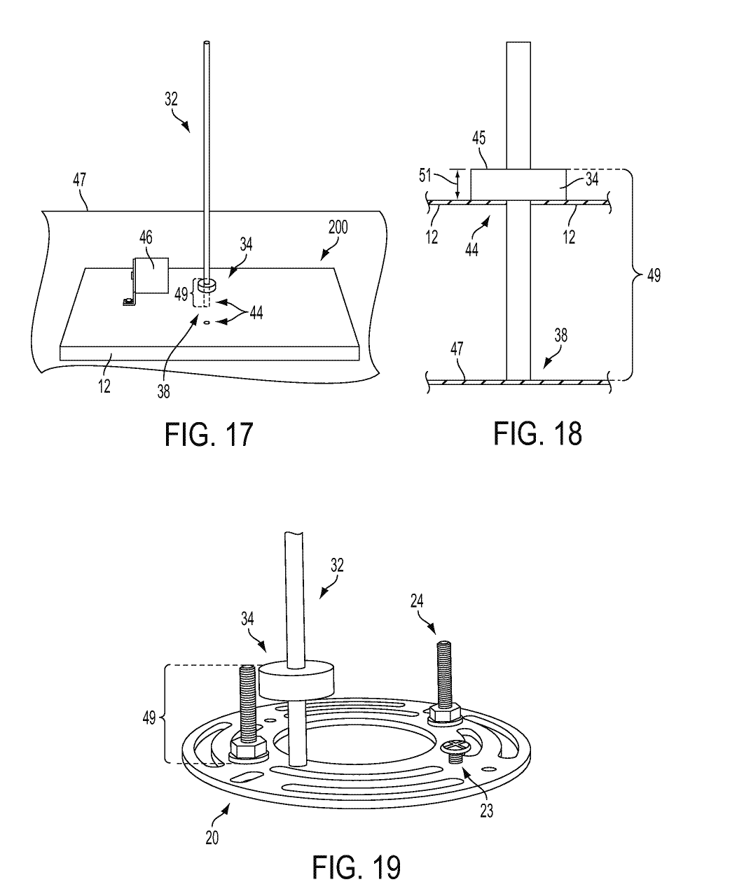

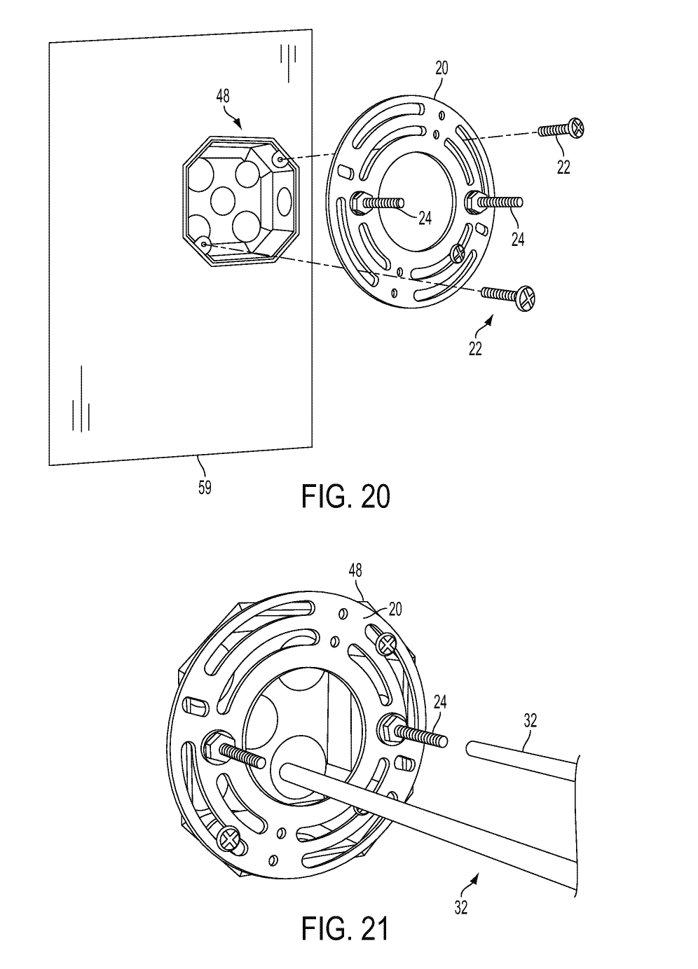

FIG. 16 illustrates a method 300 for installing a light fixture to a vertical wall according to some embodiments. It should be noted that the EMM 32 and retaining elements 34 of FIGS. 16-25 may be substantially the same as previously discussed above with regard to FIGS. 1-15. In block 302 of FIG. 16 and as illustrated by FIGS. 17-18, the EMM 32 is used to measure the distance 49 between a fiat surface 47 and the combined height of the fixture pan 12 from the flat surface 47 plus an incremental height 51. In block 304 of FIG. 16 and as illustrated in FIG. 19, the fixture mounting screws 24 are attached to the mounting bracket 20 so that the fixture mounting screws 24 extend from the mounting bracket 20 by the distance 49. In block 306 of FIG. 16 and illustrated by FIG. 20, the mounting bracket 20 is mounted to an outlet box 48 using the outlet mounting screws 22. Since the outlet box 48 is attached to a vertical wall 59, the mounting bracket 20 (once mounted) is fixed with respect to the vertical wall 59. In this regard, the fixture mounting screws 24 are parallel to the floor and extend from the vertical wall 59 by the distance 49. In block 308 of FIG. 16 and illustrated by FIG. 21, respective EMMs 32 are attached to each fixture mounting screw 24 via, threaded bores 40 in the end of each EMM 32 similar to that of FIG. 6B.

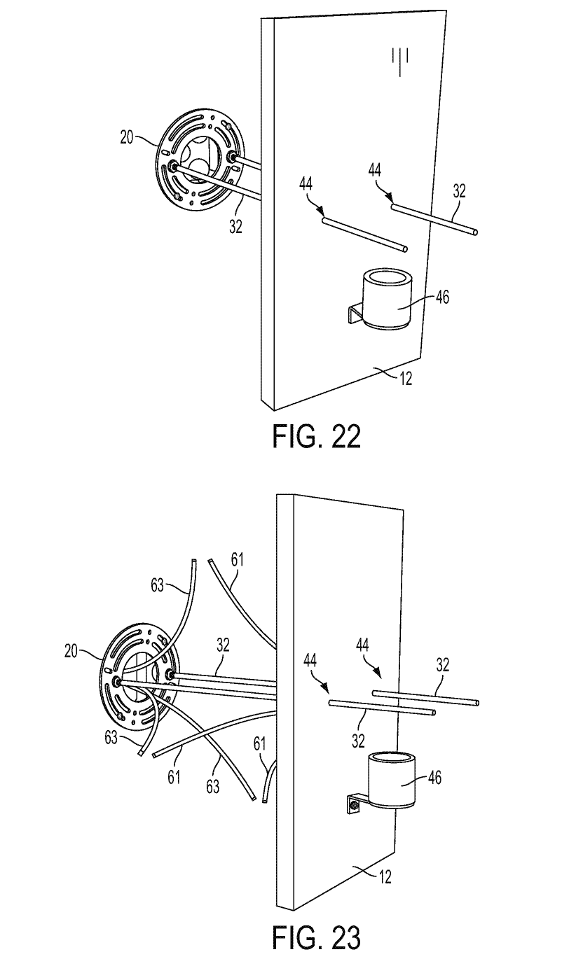

In block 310 of FIG. 16 and illustrated by FIG. 22, the fixture pan 12 is slid over each EMM 32 via mounting holes 44 in the fixture pan 12. At this point, the EMMs 32 support the weight of the fixture pan 12, whereby the weight of the fixture pan is applied perpendicular to the longitudinal axis of the EMMs 32. One skilled in the art will appreciate that retaining elements 34 may not be necessary in this case. In block 312 of FIG. 16 and illustrated by FIG. 23, the electrical wiring of all fixture wires 61 with the outlet wires 63 is completed, which is facilitated since the fixture pan 12 is supported by the EMMs 32.

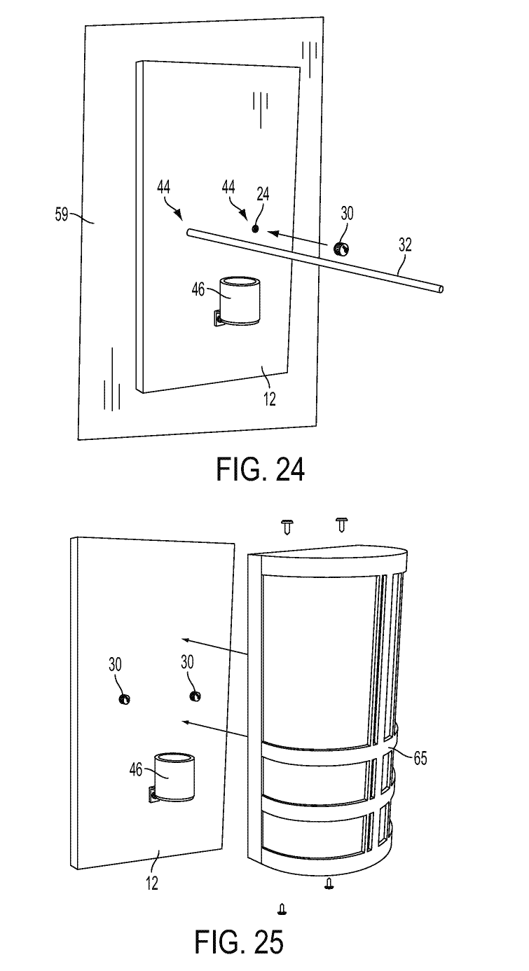

In block 314 of FIG. 16 and illustrated by FIG. 24, the fixture pan 12 slid flush against the vertical wall 59, and, after each EMM 32 is removed (one at a time), the cap nuts 30 then may be attached to the fixture mounting screws 24 which protrude through the mounting holes 44. FIG. 25 illustrates attaching a glass cage 65 to the fixture pan 12 using fasteners, thereby completing the installation of the vertical wall-mounted light fixture.

Thus, the method 300 of FIG. 16 and corresponding FIGS. 17-25 facilitates mounting of a light fixture to a vertical wall (e.g., a wall that is perpendicular to the ground). The EMMs 32 allow for the fixture pan 12 to be guided onto the fixture mounting screws 24 and also may fully support the fixture pan 12 while the wiring (or other operations) are completed. The EMMs 32 also facilitate measuring the distance 49 the fixture mounting screws 24 should extend from the mounting bracket 20.

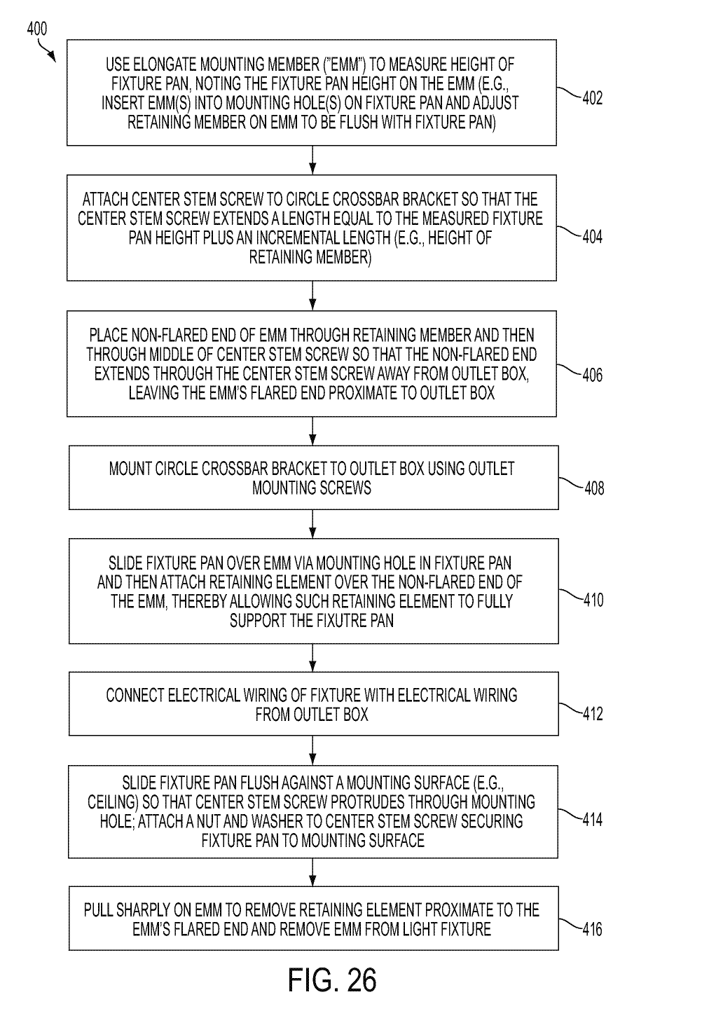

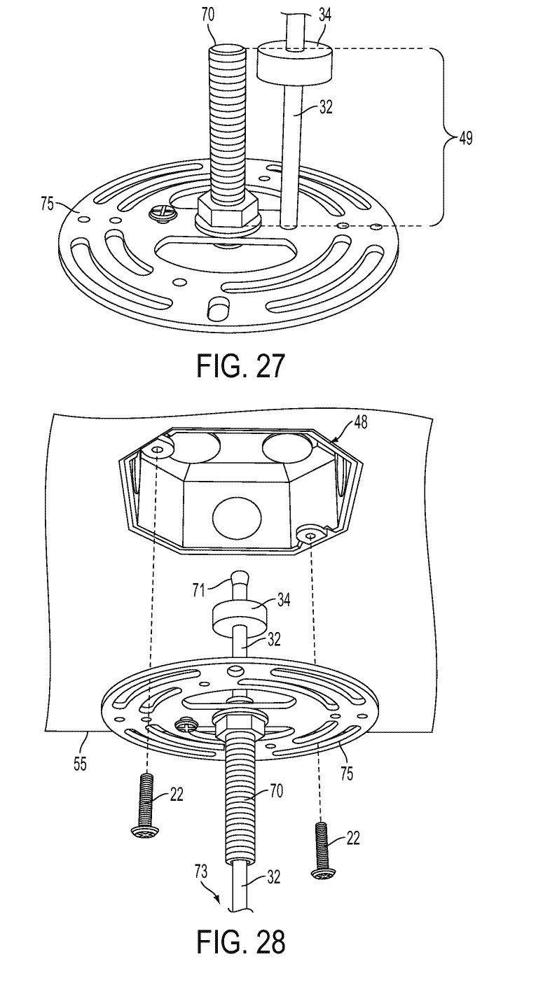

In the illustrated embodiment presented by method 400 of FIG. 26 and as illustrated by FIGS. 27-31, the present invention need not be limited to the EMMs 32 having to screw onto fixture mounting screws 24, and, in this regard, the EMMs 32 can be mounted to any other suitable component which is directly or indirectly supported by the mounting surface. For example, this embodiment utilizes a circle crossbar 75 as the mounting bracket.

Referring now to FIG. 26, in block 402, an EMM 32 is used to measure the combined distance 49 of the fixture pan 12 plus an incremental length (e.g., the thickness of the retaining element), noting the measured distance 49 on the EMM 32. In block 404, a center stem screw 70 having a hollow interior is attached to the circle crossbar bracket 75 so that the center stem screw 70 extends from the circle crossbar bracket 75 by the measured distance 49. As illustrated by FIG. 27, this may be accomplished by placing the EMM 32 adjacent to the center stem screw 70 and using the measured distance 49 noted on the EMM 32 to adjust the portion of the center stem screw 70 that extends from the circle crossbar bracket 75. Once the center stem screw 70 extends from the circle crossbar bracket 75 by the measured distance 49, the center stem screw 70 is secured in place on the circle crossbar bracket 75 such as via a nut and washer.

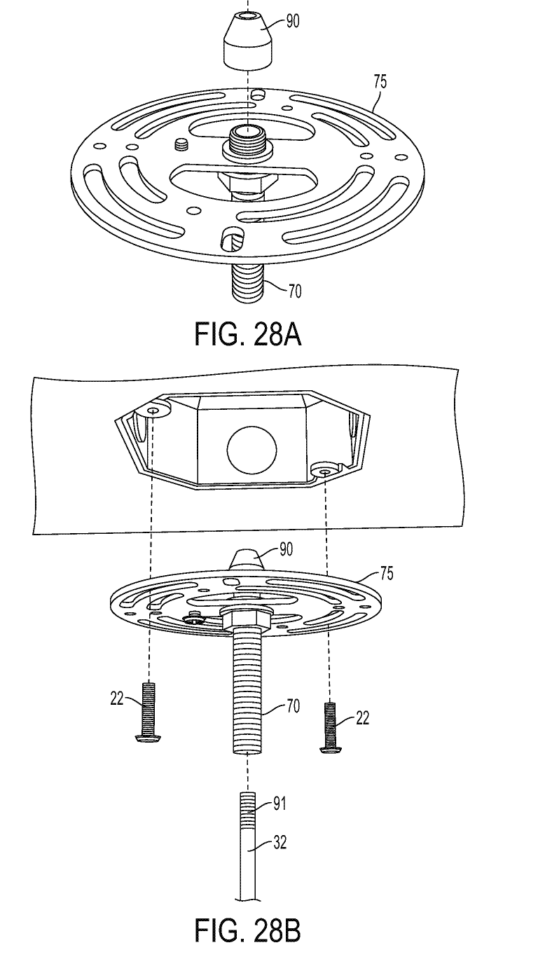

In block 406 of FIG. 26 and as illustrated by FIG. 28, the EMM 32 is inserted through the retaining element 34 and then through the center stem screw 70. In this embodiment, one end 71 of the EMM 32 is flared. The other end 73 of the EMM 32 is not flared. The non-flared end 73 of the EMM 32 is inserted into retaining element 34 first and then through the center stem screw 70 so that when the circle crossbar bracket 75 is attached to the outlet box 48, the flared end 71 will be inside box 48 and the non-flared end 73 is disposed distal from box 48 (and thus away from the mounting surface 55). In this regard, the EMM 32 is not easily removed from the circle crossbar bracket 75 when the circle crossbar bracket 75 is mounted to the outlet box 48. This is because the retaining element 34 is disposed between the mounting bracket and the EMM's flared end 71 so as to support the fixture pan. In block 408 of FIG. 26 and as illustrated by FIG. 28, the circle crossbar bracket 75 is mounted to the outlet box 48 using outlet mounting screws 22, similar to that previously discussed with regard to block 206 of FIG. 2.

In other embodiments, as illustrated in FIGS. 28A-B, a stem cap 90 may be used to secure the EMM 32 to the center screw 70. The stem cap 90 may have has two sets of female threads—a first set which allows the stem cap 90 to threadably engage the center screw 70 and a second set of female threads which allows the EMM 32 to be connected thereto. In this regard, the first set of female threads has a larger diameter than the second set of threads. In one embodiment, the EMM 32 may have a set of male threads 91 (as illustrated in FIG. 28C) on its outer surface, which mates with the second set of female threads of the stem cap 90. This allows the stem cap 90 to be secured to the center screw 70 and also for the EMM 32 to be secured to the stem cap 90. Thus, the EMM 32 will be supportably secured to the crossbar 75, which is itself secured to box 48. When the EMM 32 needs to be removed from the system, the EMM 32 is simply unscrewed from the stem cap 90 and pulled down. One skilled in the art will appreciate that it may be desirable for the first set and second set of threads of stern cap 90 to be opposite handed.

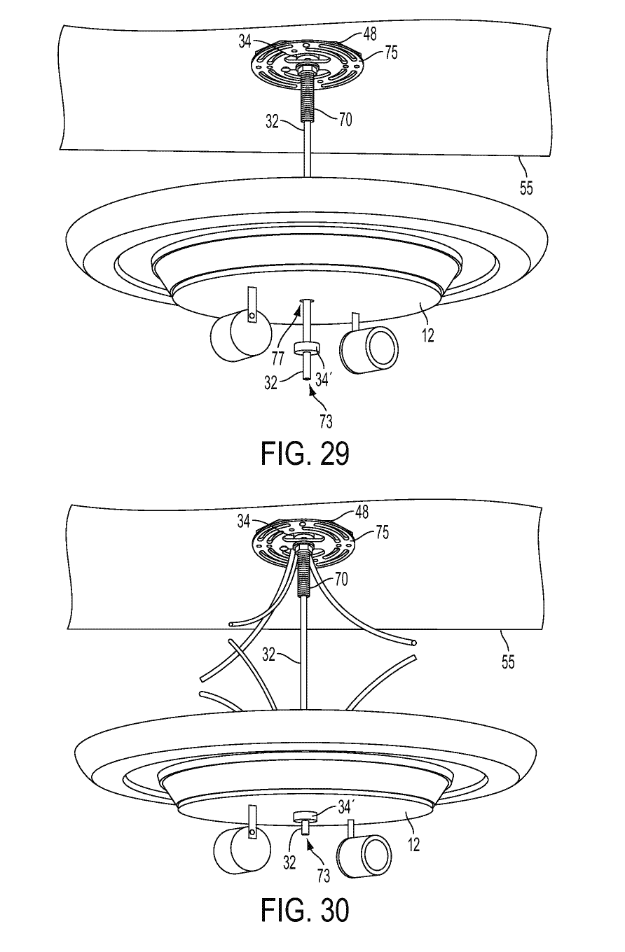

In block 410 of FIG. 26 and illustrated by in FIG. 29, the EMM 32 is received in mounting hole 77 of fixture pan 12. Another retaining element 34′ is located on the EMM 32 near end 73. This allows the retaining element 34′ at the non-flared end 73 of the EMM 32 to support the fill weight of the fixture pan 12 on the EMM 32 so that the installer's hands can be free. It should be noted that the retaining element 34′ at the non-flared end of the EMM 32 transfers the weight of the fixture pan 12 to the retaining element 34 disposed at the flared end 71 of the EMM 32, which, in turn is then distributed against the circle crossbar bracket 75. The weight borne by the circle crossbar bracket 75 is then distributed to outlet box 48. Therefore, the retaining elements 34, 34′ on both ends of the EMM 32 function together with the EMM 32 to suspend the fixture pan 12 in place but spaced apart from the mounting surface 55.

In block 412 of FIG. 26, since the installer's hands are free, electrical wiring or any other operations can be performed. For example, in the illustrative embodiment of FIG. 30, electrical wiring is being connected while the fixture pan 12 is being supported by the retaining element 34′. It should be appreciated that operations other than electrical wiring connections can be performed, such as adjusting the mounting particulars or other operations as previously discussed.

It should also be understood that one or both of the retaining elements 34, 34′ may be a resilient washer configured to snugly fit about the perimeter of the EMM 32 or, as previously discussed, one or more of the retaining elements 34, 34′ may be any other suitable article, such as a v-spring. For example, in the embodiment of FIG. 28, retaining element 34 may be a resilient washer with retaining element 34′ being a v-spring 100. Various embodiments of the retaining element are possible and are within the scope of the present disclosure, as has been previously discussed.

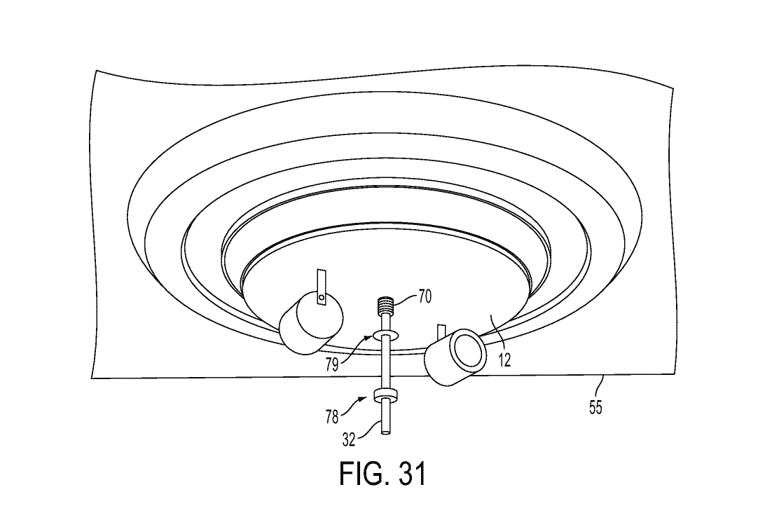

In block 414 of FIG. 26, the fixture pan 12 is slid flush against the mounting surface so that the center stem screw 70 protrudes through the mounting hole 77. As shown in FIG. 31, a nut 78 and washer 79 is attached to the protruding portion of the center stem screw 70 to secure the fixture pan 12 against the mounting surface 55. In the embodiment of FIG. 28, the EMM 32 is removed by pulling sharply down such that the retaining element 34 is left in outlet box 48 (step 416).

After the fixture pan 12 is secured to the mounting surface 55, the fixture installation can be completed as previously discussed, such as by attaching a glass shade.

### Mounting Various Objects to A Mounting Surface Using EMM(s)

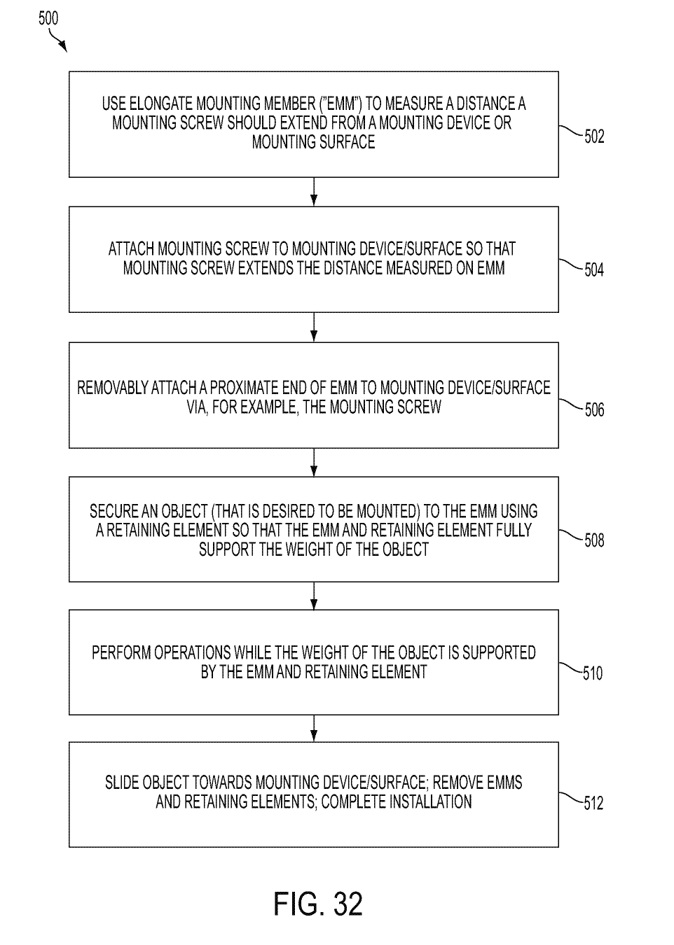

While some of the above embodiments relate to installing light fixtures and other fixtures, it should be understood that embodiments of the present invention relate to installing various other Objects to a mounting surface, as will be presented below with regard to the method 500 of FIG. 32.

FIG. 32 illustrates a method 500 of installing an object to a mounting surface using at least one EMM and at least one retaining element according to some embodiments. Various objects and mounting surfaces are possible, such as mounting a keyboard tray (the object) to the undersurface of a desk (the mounting surface).

In block 502, the EMM may be used to measure a distance that a mounting screw (or other fastener) should extend from a mounting device (e.g., a mounting bracket) or from the mounting surface itself. In block 504, the mounting screw is attached to the mounting device/surface so that the mounting screw extends the distance measured by the EMM.

While blocks 502 and 504 are discussed above as part of method 500, it should be understood that some embodiments do not require blocks 502 and 504 to be performed and method 500 may instead begin at block 506.

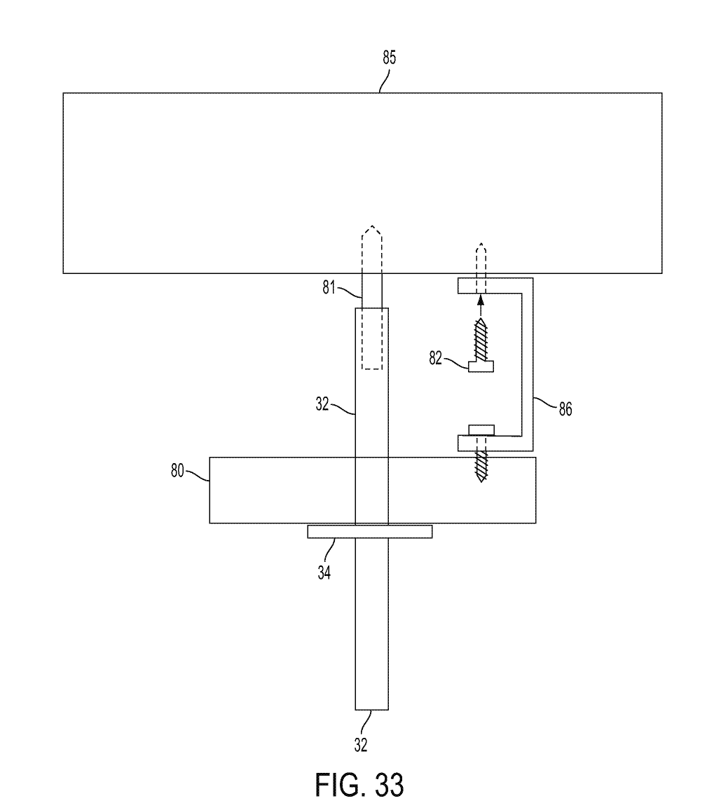

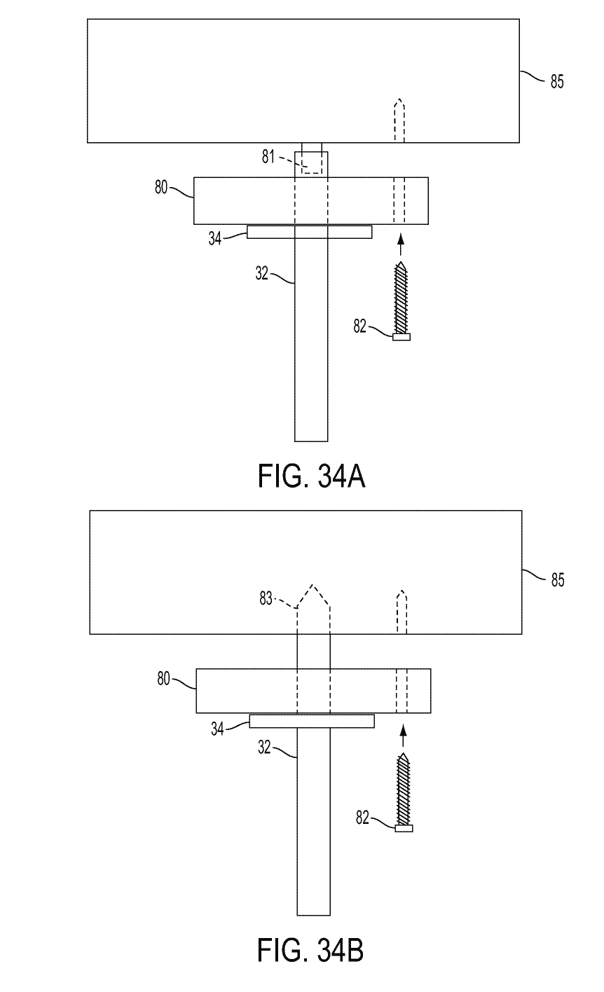

In block 506, a proximate end of the EMM is attached to the mounting device or mounting surface. For example, the proximate end of the EMM may be attached directly to a mounting screw that extends from the mounting device/surface. In another example, the EMM may be mounted directly to the mounting surface or mounting device, such as attaching the EMM to the mounting surface by screwing the EMM into the mounting surface. These mounting embodiments are discussed in more depth below with regard to FIGS. 33 and 34A-B.

Regardless, in block 508, the object to be mounted is then secured to the EMM using a retaining element. The retaining element, as previously discussed, may be separate from the EMM or a part of the EMM. In the event that the retaining element is a separate element, the retaining element is attached to the EMM so that the EMM then supports the weight of the object. For example, a v-spring may be disposed on the distal end of the EMM while the proximate end of the EMM is attached to the mounting surface. This allows the object to rest on the retaining element.

In block 510, operations may be performed while the weight of the object is supported by the EMM and retaining element. In block 512, the installation may be completed by sliding the object toward the mounting surface and performing any other installation operations. The EMM and retaining element are then removed from the object and mounting surface/device.

FIG. 33 shows an exemplary object 80 being mounted to a mounting surface 85 using an EMM 32 and retaining element 34 according to an embodiment. The mounting surface can be any surface, such as a ceiling, a wall, another apparatus, or the like. For example, the object 80 could be a keyboard tray that is to be installed to the underside of a desk via a bracket 86. As illustrated, the EMM 32 could be attached to a screw 81 or other suitable fastener that is, in turn, attached to the mounting surface 85. The EMM 32 is then supported with respect to the mounting surface 85. It should be noted that the screw 81 may be a hanger bolt that is half wood screw and the other half being machine threads so that the wood screw portion can be attached to the mounting surface 85 while the machine thread portion can be attached to the EMM 32 (via a threaded bore in the end of EMM 32).

The object to be mounted is then slid onto EMM 32 via a hole defined therein. The retaining element 34 (which could be a rubber washer, v-spring, etc. as previously discussed) is then attached to the end of the EMM 32 to support the object 80 while the bracket 86 is being attached to the mounting surface 85 such as by a screw 82.

FIGS. 34A-34B illustrate block diagrams of an object 80 being mounted to a mounting surface 85 using an EMM 32 and retaining element 34 according to another embodiment. In FIGS. 34A-34B, the object 80 is being supported while an installer screws the screw 82 directly into the mounting surface 85. FIG. 34A is similar to the process discussed above with regard to FIG. 33 but without a bracket. Instead, when the object 80 is supported by the retaining element 34, the screw 82 can be easily attached to the mounting surface 85 through the object 80 so that the object 80 is secured to the mounting surface 85.

FIG. 34B illustrates an embodiment where the EMM 32 can be directly attached to the mounting surface 85 instead of a mounting screw 81 to support the EMM 32. As illustrated, the EMM 32 may have a screw tip 83 (e.g., in the form of a wood screw) that can be screwed into the mounting surface 85 so that the EMM 32 can be attached to the mounting surface 85 at any location. In this case, one skilled in the art will appreciate that screw tip 83 should penetrate enough to fully support EMM 32 but without going all the way through.

It should he emphasized that the embodiments illustrated are only some embodiments and various other embodiments are also possible whereby the EMM and retaining elements support an object while mounting the object to the mounting surface. It should also be noted that any of the described features or embodiments could be used with any other described embodiment and thus should not be limited to the described embodiment. For example, in some cases, the EMM embodiment described in FIG. 15 could be used with the embodiment described in FIG. 33.

While one or more embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed is:

1. A method for mounting a lighting fixture to a mounting surface, the method comprising:
attaching an elongate mounting member (“EMM”) to a fixture mounting screw so that the EMM is supported by the fixture mounting screw;
disposing the EMM through an aperture of a fixture pan of the lighting fixture;
connecting a retaining element to the EMM so that the retaining element supports the fixture pan while the fixture pan is separated from the mounting surface, thereby allowing an installer to perform operations without the installer having to hold the fixture pan;
moving the fixture pan along the EMM towards the mounting surface; and
removing the EMM from the fixture mounting screw.

2. The method of claim 1, further comprising:
measuring, using the EMM, a distance representing a height of a fixture pan of the light fixture plus an incremental length;
attaching the fixture mounting screw to a mounting bracket so that the fixture mounting screw extends from the mounting bracket the measured distance; and
mounting the mounting bracket to be fixed with respect to the mounting surface.

3. The method of claim 2, wherein the measuring, using the EMM, a distance representing a height of a fixture pan of the lighting fixture plus an incremental length comprises:
placing the fixture pan on a substantially flat surface;
inserting the EMM in the aperture of the fixture pan until a first end of the EMM makes contact with the substantially flat surface;
placing a marker element on a second end of the EMM and adjusting the marker element until the marker element is adjacent to the fixture pan so that the distance representing the height of the fixture pan plus the incremental length comprises a measured distance between the first end of the EMM and a portion of the marker element placed on the EMM.

4. The method of claim 3, wherein the marker element is the retaining element and the top surface of the retaining element indicates the distance representing the height of the fixture pan plus the incremental length.

5. The method of claim 1, wherein the moving the fixture pan along the EMM towards the mounting surface comprises sliding the fixture pan along the EMM so that the fixture mounting screw protrudes through the aperture.

6. The method of claim 5, further comprising attaching a ‘nut to the fixture mounting screw after the EMM has been removed from the fixture mounting screw, the nut being configured to support at least a portion of the fixture pan when secured to the fixture mounting screw.

7. The method of claim 5, wherein the removing the EMM from the fixture mounting screw occurs after the fixture pan is slid along the EMM so that the fixture mounting screw protrudes through the aperture.

8. The method of claim 1, wherein the connecting a retaining element to the EMM comprises attaching the EMM to the fixture mounting screw via threaded engagement.

9. The method of claim 1, further comprising:
connecting a second EMM to a second fixture mounting screw;
disposing the second EMM through a second aperture of the fixture pan;
attaching a second retaining element to the second EMM so that the second retaining element supports the fixture pan; and
removing the second EMM from the second fixture screw after the second fixture mounting screw is disposed through the second aperture in the fixture pan.

10. The method of claim 1, wherein the retaining element comprises one of a v-spring, resilient washer, an o-ring, a cotter pin or a hitch pin.

11. A system for mounting a lighting fixture to a mounting surface, the system comprising:
an elongate mounting member (“EMM”) comprising:
a first end;
a second end; and
a shaft between the first and second ends,
wherein the second end of the EMM is configured to connect to a fixture mounting screw that is attached to a mounting structure, and wherein the EMM is configured to be received by an aperture defined by a fixture pan of the light fixture; and
a retaining element configured to be removably attachable to a portion of the shaft of the EMM and, when attached to the EMM, configured to support the fixture pan so that the fixture pan is separated a distance from the mounting structure that allows an installer to perform operations between the fixture pan and the mounting surface.

12. The system of claim 11, wherein the EMM further comprises a threaded bore configured to receive the fixture mounting screw at the second end thereof.

13. The system of claim 11, wherein the EMM is further configured to be removed from the fixture mounting screw when the fixture pan is adjacent to the mounting surface so that the fixture pan can be secured to the mounting surface.

14. The system of claim 11, wherein the retaining element comprises one of a v-spring, a resilient washer, an o-ring, a cotter pin or a hitch pin.

15. The system of claim 11, wherein a portion of the shaft of the EMM is textured to augment friction between the EMM and the retaining element,

16. The system of claim 11, father comprising the lighting fixture, the lighting fixture comprising the fixture pan, the mounting bracket, the fixture mounting screw, a nut configured to attach to the fixture mounting screw to the mounting bracket, an outlet mounting screw and a nut to attach the fixture pan to the fixture mounting screw.

17. The system of claim 11, wherein the mounting surface is aligned substantially perpendicular to the force of gravity such that when the fixture pan is disposed on the retaining element, the weight of the fixture pan is applied substantially parallel to a longitudinal axis of the shaft of the EMM.

18. The system of claim 11, further comprising:
a second EMM; and
a second retaining element,
wherein the second EMM is configured to connect to a second fixture mounting screw that is attached to the mounting surface,
wherein the second EMM is configured to be received by a second aperture defined by the fixture pan, and
wherein the second retaining element is configured to be removably attachable to the second EMM so that, when attached to the second EMM, the second retaining element is configured to support the fixture pan.

19. The system of claim 11, wherein the EMM and retaining element fully support the weight of the fixture pan so that fixture pan is able to be suspended from the mounting surface without the installer having to support the fixture pan.

20. A method for mounting an object to a mounting surface, the method comprising:
attaching a proximate end of an elongate mounting member (“EM”) to a mounting structure so that the EMM is fixed with respect to the mounting surface;
disposing the EMM through an aperture of the object;
connecting a retaining element to a selected location on the EMM so that the retaining element supports the object while the object is separated from the mounting surface, thereby allowing a user to perform operations without the installer having to hold the object;
completing installation of the object to the mounting surface; and
removing the EM M from the mounting surface and from the object.

21. The method of claim 20, wherein the proximate end of the EMM is attached directly to the mounting surface.

22. The method of claim 20, wherein the attaching a proximate end of an elongate mounting member (“EMM”) to a mounting structure so that the EMM is supported by the mounting surface comprises:
threadably engaging the proximate end of the EMM to a mounting screw after the mounting screw has been fixed in position with respect to the mounting surface.

23. The method of claim 22, further comprising:
measuring, using the EMM, a distance representing a distance that the mounting screw should extend from the mounting surface; and
attaching the mounting screw with respect to the mounting surface so that the mounting screw extends from the mounting surface the measured distance.

24. The method of claim 20, further comprising sliding the object along a shaft of the EMM towards the mounting surface so that the installation of the object can be completed.

25. The method of claim 20, wherein the mounting surface comprises a surface of a piece of furniture.

26. The method of claim 20, wherein the mounting surface comprises a ceiling or a vertical wall.

27. A method for mounting a lighting fixture to a wall, the method comprising:
attaching an elongate mounting member (“EMM”) to a fixture mounting screw so that the EMM is supported by the fixture mounting screw;
disposing the EMM through an aperture of a fixture pan of the lighting fixture so that the EMM supports the fixture pan while the fixture pan is separated from the wall, thereby allowing an installer to perform operations without the installer having to hold the fixture pan;
moving the fixture pan along the EMM towards the wall; and
removing the EMM from the fixture mounting screw.

28. The method of claim 27, further comprising:
measuring, using the EMM, a distance representing a height of a fixture pan of the lighting fixture plus an incremental length;
attaching a fixture mounting screw to a mounting bracket so that the fixture mounting screw extends from the mounting bracket the measured distance; and
mounting the mounting bracket to be fixed with respect to the mounting surface.

29. The method of claim 27, wherein the moving the fixture ail along the EMM towards the mounting surface comprises sliding the fixture pan along the EMM so that the fixture mounting screw protrudes through the aperture.

30. The method of claim 27, further comprising:
connecting a second EMM to a second fixture mounting screw;
disposing the second EMM through a second aperture of the fixture pan so that the second EMM supports the fixture pan; and
removing the second EMM from the second fixture screw after the second e s mounting screw is disposed through the second aperture in the fixture pan.

31. The method of claim 27, wherein the wall comprises a vertical wall such that when the fixture pan is disposed on the EMM, the weight of the fixture pan is applied perpendicular to a longitudinal axis of the EMM.
